(19) United States
(12) Patent Application Publication
(10) Pub. No.: US 2018/0342248 A1
(43) Pub. Date: Nov. 29, 2018

(54) INTEGRATED SPEECH RECOGNITION TEXT INPUT WITH MANUAL PUNCTUATION

(71) Applicant: Ronen Rabinovici, Giv'at Shmuel (IL)

(72) Inventor: Ronen Rabinovici, Giv'at Shmuel (IL)

(21) Appl. No.: 15/602,602

(22) Filed: May 23, 2017

(51) Int. Cl. G10L 15/26; G06F 17/24; G06F 3/023; G10L 15/183; G10L 15/22; H04M 1/27; H04W 4/14

(52) U.S. Cl. CPC G10L 15/26; G06F 17/24; G06F 3/0233; H04M 2250/74; G10L 15/22; H04M 1/271; H04W 4/14; G10L 15/183

(57) ABSTRACT

An integrated system and method for text-input, combining and syncing speech input together with manual input, to improve speech-recognition-based text input both in speed and accuracy, when punctuation and other symbols are needed and when speech-recognition results are to be combined with previously-existing text. Facilitates the strong points of speech-recognition technology, which are speed and comfort when inputting common words, while at the same time facilitates the strong points of manual key-typing, which are speed, comfort and accuracy when inputting punctuation marks, symbols, or pre-defined text with a single click. Increases speed, accuracy and comfort of speech-recognition text input by solving the problems of current voice-typing methods, and by further using the data from the manual input for improving speech recognition results.

### BACKGROUND OF THE INVENTION

### Field of the Invention

The present invention relates to text input systems and methods, specifically to those based on speech-recognition, also known as voice-typing.

### Description of Related Art

Automatic speech recognition is growing in popularity as a text-input method. This method is sometimes referred to as voice-typing. It is used on a large range of devices, from desktops through mobile devices, wearables, augmented reality, virtual reality, and so on.

Existing voice-typing solutions suffer from numerous problems when needing to insert punctuation marks or other non-alphanumeric symbols.

Most common solution to using punctuation marks when voice-typing is simply to dictate the punctuation mark and let it be recognized as such by the speech recognizer. That solution suffers from a few issues: (1) time consuming (2) prone to recognition errors (3) symbol is not at all recognized by the speech recognizer as a symbol (4) user is not familiar with the exact name of the symbol in order to dictate it.

Time consuming. Time is spent both on dictating the punctuation mark as well as on the process of recognizing it by the speech recognizer.

The second issue is that this solution will frequently result in mistakes in understanding the punctuation mark due to ambiguities. This speech recognizer will occasionally have trouble understanding whether the speaker intended for the symbol or for the word itself. For instance, the word “period” could be interpreted either as the word “period”=length of time, or as the mark “.”. Both interpretations are based on correct recognition of the speech. Add to that the fact that the speech recognizer is not always accurate, the result is frequent punctuation-related mistakes.

Dictated symbol not recognized by speech recognition engine, as the engine is limited in the number of words/phrases it recognizes as symbols. Most emojis for instance are not recognized by speech recognition engines.

If the same symbol has different names in a language, as many times the case is for marks, the user might use a name for the symbol that is not the name for that symbol as the speech recognition was programmed to recognize, which will result in not recognizing it as a symbol—but as plain words. For instance, ‘new line’ versus ‘new paragraph’. Or ‘full stop’ versus ‘period’.

An additional approach to punctuation is automatic punctuation. When the speech recognizer recognizes a longer pause in speech it then analyzes the structure and content of the underlying sentence and tries to close it with a matching punctuation mark. While this approach is very useful for transcribing natural speech as in a conversation, it is problematic for voice-typing. When a user dictates, when will frequently pause without any meaning to end a sentence. Moreover, while in a conversation the difference between a period and a comma might not be significant, in a text-input method a mistake in inserting the punctuation mark is unacceptable.

Another common and very practical approach is simply to allow the user to switch between input modes—voice-typing or key-typing. Although straightforward, this solution slows down typing and cumbersome for the user.

Another existing approach, is to enable the user to type the marks while still in dictating mode. That approach is also insufficient. As speech-recognition is always asynchronous, speech results will often come after the user typed the mark. This will result in the mark preceding the speech results, even if it was in fact typed after the user dictated the text. In order to avoid that flip, the user must wait for the speech results before being able to type the mark. This waiting consumes a lot of time as the user usually will have to pause his speech long enough for the speech recognizer to understand it is the end of the utterance.

Moreover, when combining speech recognition results with typed text, it will often result in mistakes in the capitalization of the speech results, or in wrong-spacing between the typed text to the speech results. These mistakes, will then require lengthy and careful editing by the user.

Perhaps the most important things in speech recognition are its accuracy and its speed. In order to increase accuracy levels, the most accurate speech recognition engines today analyze not only word by word, but also the sequence as a whole. For that purpose, exactly, the knowledge about the end of the sequence is significant for processing and finalizing the results. Today, speech recognizers recognize the end of a sequence by recognizing a long pause in speech at its end. While that works, these longer pauses slow down the whole text input process.

US patents U.S. Pat. No. 5,937,380, U.S. Pat. No. 7,574,356, and U.S. Pat. No. 8,571,862 combine speech recognition and manual input, but from a different aspect and in a different implementation. Their key-typing input is the first letter or letters of a spoken word—in order to narrow down the dictionary for recognizing that word and to help with spelling—mostly of names. They do not address at all the aspect of simultaneously adding actual and different content both from the key-typing and from the speech as two independent sources of text-input. For that reason, neither do they cover key-typing post a speech utterance, but rather pre-speech or within speech—per word.

### BRIEF SUMMARY OF THE INVENTION

System and method for synchronizing and integrating the speech-recognition together with manual input of punctuation marks and additional enhancements to improve the speed and accuracy of speech-recognition-based text-input. Enabling manual input (by typing or other means) of punctuation marks, while voice-typing.

The invention gracefully allows to facilitate the strong points of speech-recognition technology, which are speed and comfort when inputting common words, while at the same time to facilitate the strong points of manual key-typing, which are speed, comfort and accuracy when inputting punctuation marks, symbols, or pre-defined text with a single click.

The invention increases speed, accuracy and comfort of speech-recognition text input by solving the problems of current voice-typing methods, and by further using the data from the manual input for improving speech recognition results.

The main problems the invention solves: (1) having to switch between voice-typing mode to key-typing mode for adding text or marks, or having the manual input interrupt speech recognition; (2) consuming time on dictating punctuation marks, symbols and other pre-defined text-blocks (such as email address)—instead of single-clicking them; (3) mistakes in recognizing the dictated symbol (4) recognizing speech correctly but not recognizing the results should be used as a symbol—but rather interpreting it as plain text; (5) users are unaware which symbols can be dictated and using what commands (6) symbols in multi-lingual systems.

In addition to solving the above problems, the speech recognizer will use that information in the following two ways: (1) As a signal to end the current sequence. That will save the time otherwise needed for the speech recognizer in order to recognize the end of sequence by itself, either by waiting for a long pause in speech or otherwise. The knowledge that the sequence is closed is used by the speech-recognizer to further improve the speech-recognition results by analyzing the sequence as a whole. (2) The information about the specific punctuation mark chosen by the user to close that sequence is used for reducing ambiguities and further refine the results. The over-all text-input time is shortened once more by eliminating the need to dictate and speech-recognize the punctuation mark itself. This also prevents additional potential recognition mistakes and ambiguities.

In addition, careful automatic capitalization and spacing of new text results, by analyzing the existing text in the text-input element that is preceding the location where the new results should be inserted to (usually caret location). New results will be capitalized, only if new results are starting a new sentence or new line, based not on the results themselves, but, rather on the ending of the preceding existing text in the input-element. Prefixing new results with space or attaching them to previous text, will be automatically done based on analyzing the ending of preceding existing text together with analyzing the beginning of the new results.

In addition, enabling real-time selection of best result out of ambiguous results. Displaying ambiguous results (of sequence or some specific words within the sequence), optionally—partial results, and allowing the user to select the best match so far. The speech recognizer will then use that information to improve its final results and shorten processing time, by eliminating the need to further analyze irrelevant branches of assumptions. Ambiguity in results could be both on the single-word-level and on the sequence-level.

### BRIEF DESCRIPTION OF THE DRAWINGS

FIG. 1A is a block diagram of a text-input system 100 with integrated speech recognition and manual punctuation, according to a basic embodiment of the invention.

FIG. 1B is a block diagram of a processing module 131 in the system, according to one embodiment of the invention. The processor 131 can, for example, represent an embodiment of the processor 130 shown in FIG. 1A.

FIG. 2 illustrates a possible embodiment of the invention, specifically on a device 200 that supports touch-screen, such as a mobile phone or a tablet. This possible embodiment of the invention makes use of the touch-screen and soft-keys 220 for the manual input device 120 shown in FIG. 1A.

FIG. 3 is a flow diagram of the integrated text-input system, according to one embodiment of the invention.

FIG. 4 is a flow diagram, according to one embodiment of the invention, of the part of the invention, that enhances the integrated text-input with careful automatic capitalization of new text results and spacing them (or attaching them) to existing text. As such, element 400 is responsible for the smart insertion of the transcription results into the text-input element. Element 400 can, for example, represent an embodiment of element 360 in FIG. 3.

### DETAILED DESCRIPTION OF PREFERRED EMBODIMENTS OF THE INVENTION

The invention is an integrated system and method for text-input, combining and syncing speech input together with manual input, to improve speech-recognition-based text input both in speed and accuracy, when punctuation and other symbols are needed and when speech-recognition results are to be combined with previously-existing text. As such, the invention integrates speech-recognition with manual punctuation input, smart context-aware text insertion and user-enhanced real-time ambiguity resolution. In punctuation input we include both punctuation marks and any other significant symbols for the post-speech-sequence text input or for the speech-recognition flow, such as “end sequence” and “cancel sequence” commands.

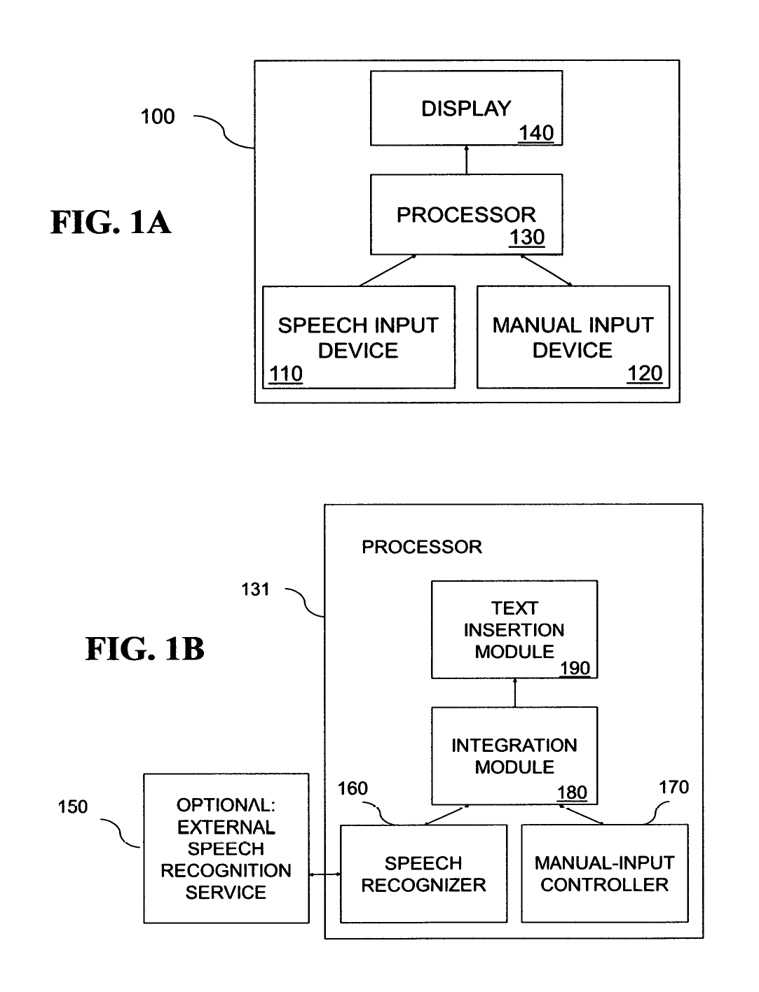

Embodiments of these aspects of the invention are discussed with reference to FIGS. 1-4. The detailed description given with respect to these figures is for explanatory purposes, as the invention extends beyond these limited embodiments.

FIG. 1A is a block diagram of a text-input system 100 with integrated speech recognition and manual punctuation, according to a basic embodiment of the invention. It constitutes of the following main elements: (1) The first is the device used for the speech input 110. It is a combination of a microphone of some sort and the electronics behind it necessary to depict the speech, such as the analog to digital, amplifier, noise reduction elements and etc. For example, on a mobile phone that could be the inner microphone and its capturing electronics, or an external microphone connected through the audio jack with the phones own electronics, or even a Bluetooth microphone that already captures and digitalizes the audio signal outside the mobile phone. (2) The second element is the manual-input device 120. The manual input is used by the invention for two purposes: The first—for the manual input of punctuation marks, which can occur simultaneously with the speech recognition. The second—for the real-time manual selection of best result out of a few ambiguous speech results. Manual input device can be any device capable of the task, for instance a regular keyboard, a mouse (clicking on soft-keys on screen), a touch-screen showing the keys and buttons, joystick or other. (3) The processor 130 is in charge of taking these two input methods, integrating them and output the results for the user onto the display 140, which is the (4^{th}) main component of the system.

FIG. 1B is a block diagram of a processing module 131 in the system, according to one embodiment of the invention. The processor 131 can, for example, represent an embodiment of the processor 130 shown in FIG. 1A. Module 131 includes the element responsible for the speech recognition 160, element for controlling the key-inputs and content (in case of soft-keys) 170, element integrating the speech recognition cycle with the manual input 180 and element 190 responsible for the smart-insertion of the integrated results into the text-element. The speech recognition element 160 could be operating locally only or some combination of local and remote operation communicating with a remote speech-recognition service 150. Such a remote service 150 could be an integrated service, or a 3^{rd} party service which communicates via a defined API. In order to fully benefit from the invention, it is important that the speech-recognition element 160, or 160 combined with 150 be capable of receiving at least “end sequence” commands. Preferably for the real-time best-match selection they should be able to return partial results.

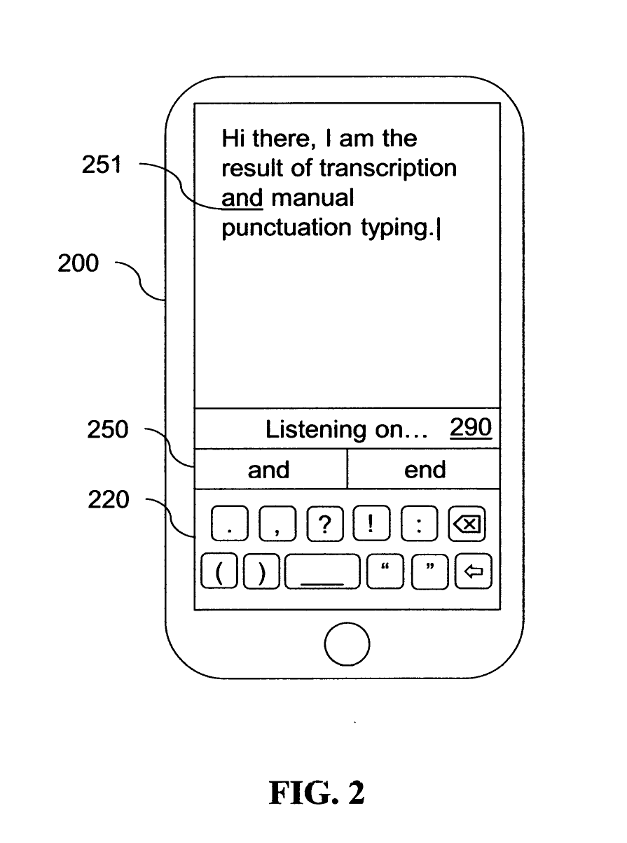

FIG. 2 illustrates a possible embodiment of the invention, specifically on a device 200 that supports touch-screen, such as a mobile phone or a tablet. This possible embodiment of the invention makes use of the touch-screen and soft-keys 220 for the manual input device 120 shown in FIG. 1A. By showing the punctuation marks 220 in parallel to active speech recognition (noted by 290) we enable the user to be much more efficient in the over-all text-input process. The user can speak a sentence and immediately click on the wanted punctuation mark once he finishes saying the sentence. Then, the user can continue with the next sentence, without the need to switch modes or any other button click. The integrated system takes care of appending the punctuation mark typed to the spoken text in the order of input (and not in the order of the received results from the speech recognizer). The system also takes care of correct capitalization and spacing previous text from new text results. In case the user types in a mark, and there is no speech being processed, the keyboard will act as a regular keyboard. FIG. 2 also illustrates the real-time selection of ambiguous results. Ambiguous words (or sequences) returned by the speech recognizer are marked as such 251 and the highest-confidence results show as buttons 250. This way, the user can easily select the correct match. That selection can feed back into the speech recognizer both for speeding up current process (if it was not yet finished) by reducing possibilities and for future reference.

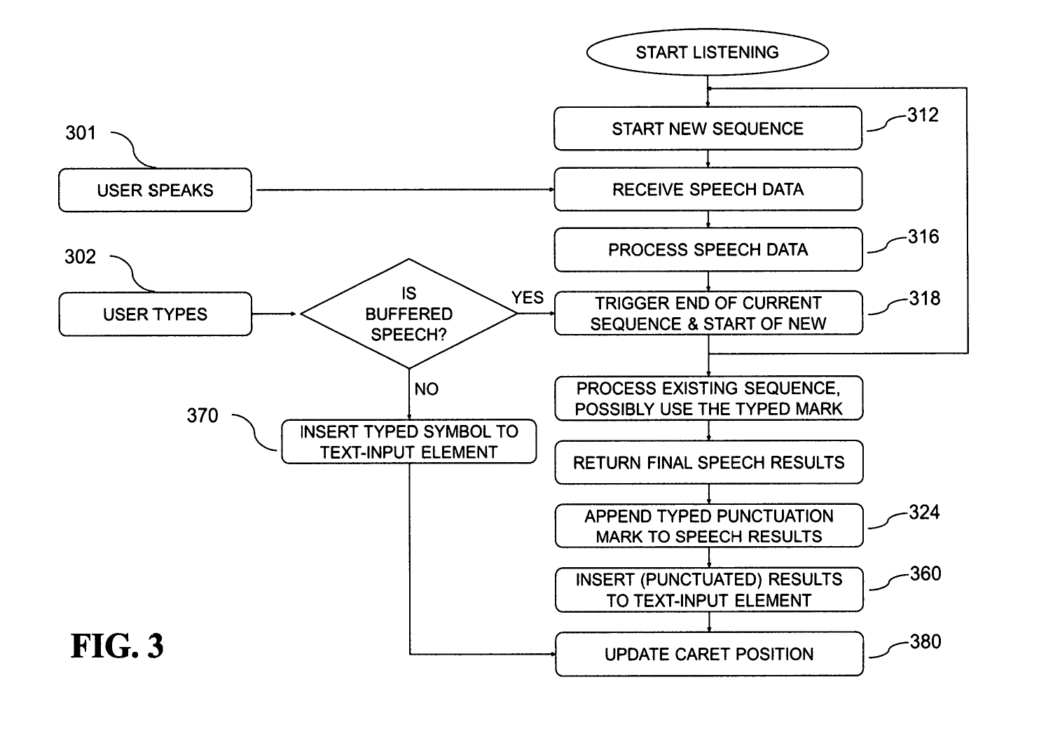

FIG. 3 is a flow diagram of the integrated text-input system, according to one embodiment of the invention. It shows how the manual input 302 is used by the speech recognition flow if it is in the process of recognizing speech. In case the manual input is typed while previous speech from 301 is being processed by 316 then an “end sequence” 318 command is being triggered. That is immediately used by the speech recognizer to improve accuracy by algorithms analyzing the sequence as a whole in addition to the word-by-word processing. By using the typed-key as a trigger, the need for a long pause to trigger “end of sequence” is eliminated, thus reducing both input and processing time. Moreover, since the marks can be typed, there is no need to dictate them for the text-input, therefore emitting two time-consuming sources: (1) The time that it takes to dictate the mark (2) The time that it takes the speech recognizer to process the speech of the dictated mark.

After triggering the end of sequence, then the speech recognizer goes into the final processing of the buffered sequence possibly using for its analysis also the information on the specific punctuation mark that was typed. The knowledge of the ending punctuation mark might hold valuable information about the underlying sentence, that is used by the speech recognizer to factor the statistical likelihood of the different possible results. For instance, if the speech recognizer got the following 2 possible results for the first words in the utterance: “What are the . . . ” and “Water the . . . ”, the knowledge on whether the punctuation mark should be a question-mark or a period holds valuable information for the statistical likelihood of option 1 versus 2. Therefore, by typing the punctuation mark, the user actually helps the speech recognition algorithms to return the more accurate result. For instance, if the user typed “?”, then from that information alone we derive that the beginning of the sentence is more likely to be “What are the . . . ”. Whereas if the user typed “.”, then “Water the . . . ” is more likely. These considerations are added when helpful to the statistical models for calculating the confidence level of each result.

Since the marks can be typed, there is no need to dictate them for the text-input, therefore emitting possible ambiguity in understanding the marks themselves by the speech recognizer. Therefore, the accuracy of the whole text-input is improved. For instance, dictating “period” is ambiguous (could mean either a length of time, or a punctuation mark) even when understood correctly by the recognizer. The situation would be even more ambiguous if the speech recognizer did not fully understand the mark. All these sources for mistakes are completely emitted when the user is enabled to manually type in the wanted punctuation mark.

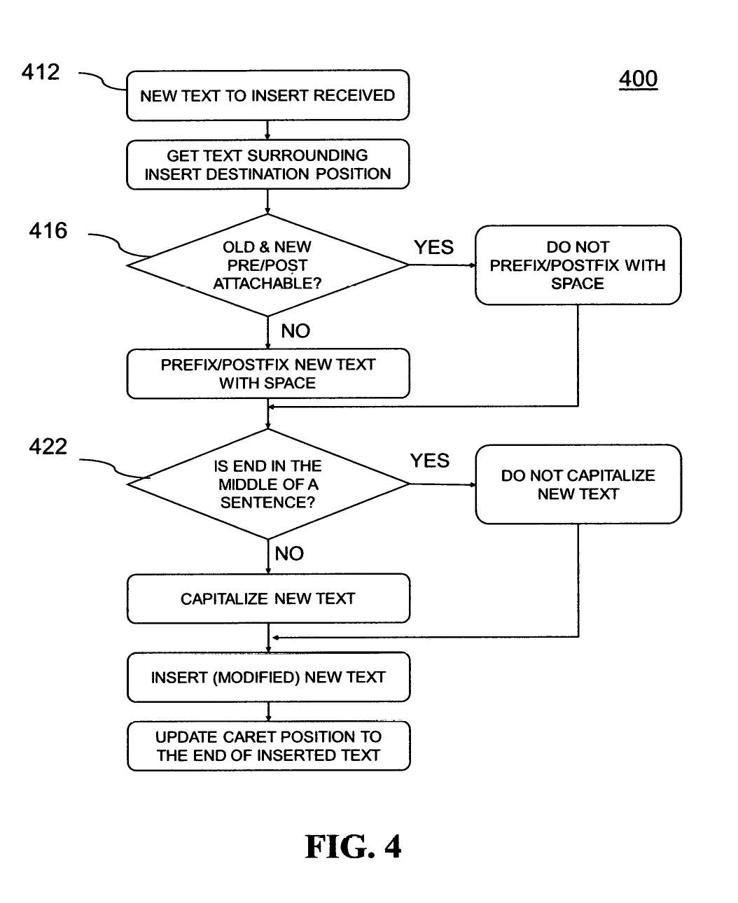

The typed punctuation mark is appended to the speech results 324, and the integrated results are then inserted into the text element 360. The smart-insertion process is described in more detail in FIG. 4 by flow diagram 400.

Parallel to, or right after finalizing the speech results for the current sequence, a new sequence is started 312, so the user can dictate and type continuously.

In the case where the manual input is typed when there is no buffered speech being recognized, then the keyboard simply acts as a regular keyboard, and the typed symbols are inserted 370 to the text element.

Last, the new caret position is updated 380 to the last place of the inserted text, making it ready for the future text results.

FIG. 4 is a flow diagram, according to one embodiment of the invention, of the part of the invention, that enhances the integrated text-input with careful automatic capitalization of new text results and spacing them (or attaching them) to existing text. As such, element 400 is responsible for the smart insertion of the transcription results into the text-input element. Element 400 can, for example, represent an embodiment of element 360 in FIG. 3. Common mistakes made by speech-recognizing-based text input methods are sticking new results to previously existing text, and wrong capitalization. By incorporating analysis of existing text surrounding the location where new results should be inserted these mistakes could be reduced. 416 represents the element in the flow that checks whether it is necessary to add a space character before or after the new results. It checks whether to add a space before the new results by analyzing the relationship between the last characters of the preceding old (existing) text and the first characters of the new text. It checks whether to add a space after the new results by analyzing the relationship between the first characters of the old (existing) text that comes after the insertion point and the last characters of the new text. For instance, if caret is placed right after the question mark in the following text: “Hi, how are you?|” and before the following text: “ Thank you.” Then, we know 3 things: (1) A space character should precede the new results, by analysis of element 416 (2) A space should not be added after the new results, as the existing text following the insertion point already has a space there. Again, by analysis of element 416. (2) New results are a new sentence and should be capitalized, analyzed by element 422.

While particular embodiments of the present invention are illustrated and described, it would be obvious to those skilled in the art that various other changes and modifications can be made without departing from the spirit and scope of the invention.

What is claimed is:

1. A text-input system and method comprising:
a speech-recognition module; and
a manual input module, specifically for punctuation marks, emoji symbols, digits and other non-alphabet symbols, simultaneously enabled with said speech-recognition module; and
an integration module that synchronizes and combines said speech recognition module and said manual-input module and their corresponding inputs and results.

2. The text-input article of claim 1, implemented on a mobile phone.

3. The text-input article of claim 1, implemented on a pc.

4. The text-input article of claim 1, implemented on a virtual reality or augmented reality device.

5. The text-input article of claim 1, wherein said manual input module comprises a virtual keyboard.

6. The text-input article of claim 1, wherein said manual input module comprises a hardware keyboard.

7. The text-input article of claim 1, wherein said manual input module is always available and enabled, including when said speech recognition module is capturing or processing speech.

8. The text-input article of claim 1, wherein said speech recognition module is always available and enabled, even when said manual input is being used.

9. The text-input article of claim 1, wherein said manual input is used after speech was spoken but before speech results are finalized, such that final-resulting text includes integrated results of both the complete speech results and the symbol from the manual input, in the order of input: symbol after speech, and not in the order of results: symbol before speech results.

10. The text-input article of claim 1, wherein said integration module calculates whether it is most probably helpful to insert a space character between speech results by said speech recognition module and punctuation marks or symbols by said manual input module and vice versa between speech results to the manually-inputted mark, based on the specific said mark and said speech results, and inserts the space character when it decides necessary.

11. The text-input article of claim 1, wherein said integration module sends punctuation marks or symbols entered by said manual input module after speech was spoken, but before speech results were finalized to said speech-recognition module.

12. The text-input article of claim 1, wherein said speech recognition module takes a punctuation mark or other non-alphabetical symbol as an additional input for the speech processing algorithms and in evaluating the confidence level of speech-recognition results.

13. The text-input article of claim 1, wherein manual input by said manual input module while said speech recognition module processes prior speech, signals to said speech-recognition module current speech-utterance is done, enabling said speech recognition module to immediately stop awaiting for more speech or a recognizable pause in order to finalize speech results.

14. The text-input article of claim 1, wherein manual input by said manual input module while said speech recognition module processes prior speech, signals to said speech-recognition module current speech-utterance is done, enabling said speech recognition further process the speech utterance as a complete utterance using sentence-level-context in order to improve speech results.

15. The text-input article of claim 1, wherein said manual input module comprises keys that represent full pre-defined (by user or by system) text.

16. The text-input article of claim 1, wherein said manual input module comprises control commands for the currently-processed speech, wherein said control-commands include:
‘End speech utterance’; and
‘Cancel speech utterance’; and
‘Finalize speech results’.

17. The text-input article of claim 1, wherein said manual input module comprises ambiguity-resolutions for the currently-processed speech, based on incoming partial speech results from said speech recognition, enabling real-time selection of best result out of possible ambiguous results.

18. The text-input article of claim 1, wherein said integration-module automatically decides on capitalization of speech-recognition results based on text already existing in the text-field prior to the current caret position.

19. The text-input article of claim 1, wherein said integration-module automatically decides on inserting a space character prior to inserting the speech-recognition results based on text already existing in the text-field prior to the current caret position.
